(19) United States
(12) Patent Application Publication
(10) Pub. No.: US 2005/0145765 A1
(43) Pub. Date: Jul. 7, 2005

(54) Chock for climbing and mountaineering

(75) Inventor: Paul Petzl, Barraux (FR)

Correspondence Address: OLIFF & BERRIDGE, PLC, P.O. BOX 19928, ALEXANDRIA, VA, 22320, US

(73) Assignee: ZEDEL, Crolles (FR)

(21) Appl. No.: 10/964,721

(22) Filed: Oct. 15, 2004

(30) Foreign Application Priority Data
Jan. 6, 2004 (FR) 04 00055

(51) Int. Cl. B60T 3/00; A47F 5/08

(52) U.S. Cl. 248/231.9; 248/925

(57) ABSTRACT

A chock for climbing and mountaineering comprises a securing part comprising on one side a first concave chocking face with three bearing zones forming a flat isostatic contact, and on the opposite side a second chocking face of convex shape having a single bearing zone close to the mid-part and constituting a pin-point contact of small surface.

### BACKGROUND OF THE INVENTION

The invention relates to a chock for climbing and mountaineering, comprising a securing part designed to be inserted in a crack of a rock, said part comprising on one side a first chocking face and on the opposite side a second chocking face so as to form nuts joined to an attachment means fixed to the part.

### STATE OF THE ART

In climbing, it is conventional to use chocks to create artificial anchors in cracks of rocks. Known nuts are generally static aluminium chocks, with two flat faces arranged in the form of dihedra or knuckles. In a regular crack, the faces substantially follow the shape of the walls of the crack and ensure efficient chocking of the nuts. The use of these known chocks in irregular cracks may give rise to problems of instability in the case where contact with the wall takes place at a single point on each side. According to the mechanical stresses exerted on the attachment rope, the chock is then liable to come unsecured by rotating around an axis passing through the two contact points.

The documents AT 395,945 and EP 106,645 describe chocks for climbing each having a convex face with three bearing points, and a concave face.

### OBJECT OF THE INVENTION

The object of the invention is to remedy these shortcomings and to achieve an improved chock enabling an optimum anchoring stability to be obtained regardless of the shape of the cracks.

According to the invention, this object is achieved by the fact that the first chocking face is equipped with three bearing zones forming a flat contact according to an isostatism principle. This results in an immobilization effect in one translation and two rotations which prevents any undesirable unsecuring as for conventional chocks. The three bearing zones are salient from the first chocking face, which presents an inwardly curved profile.

The securing effect is enhanced by the second chocking face which comprises an outwardly convex profile, having a single bearing zone forming a pin-point contact of small surface. This pin-point contact is advantageously located close to the mid-part of the second chocking face.

According to a preferred embodiment, the first face is concave and the second face is convex.

### BRIEF DESCRIPTION OF THE DRAWINGS

Other advantages and features will become more clearly apparent from the following description of particular embodiments of the invention, given as non-restrictive examples only, and represented in the accompanying drawings in which:

FIG. 1 is a perspective view of the concave face of the chock according to the invention;

FIG. 2 shows a perspective view of the convex face of the chock according to FIG. 1;

FIG. 3 represents the chock of FIG. 2 inserted in an irregular crack with non-parallel faces;

FIG. 4 schematically illustrates the distribution of the bearing zones of the chock on the walls of the crack.

### DESCRIPTION OF A PREFERRED EMBODIMENT

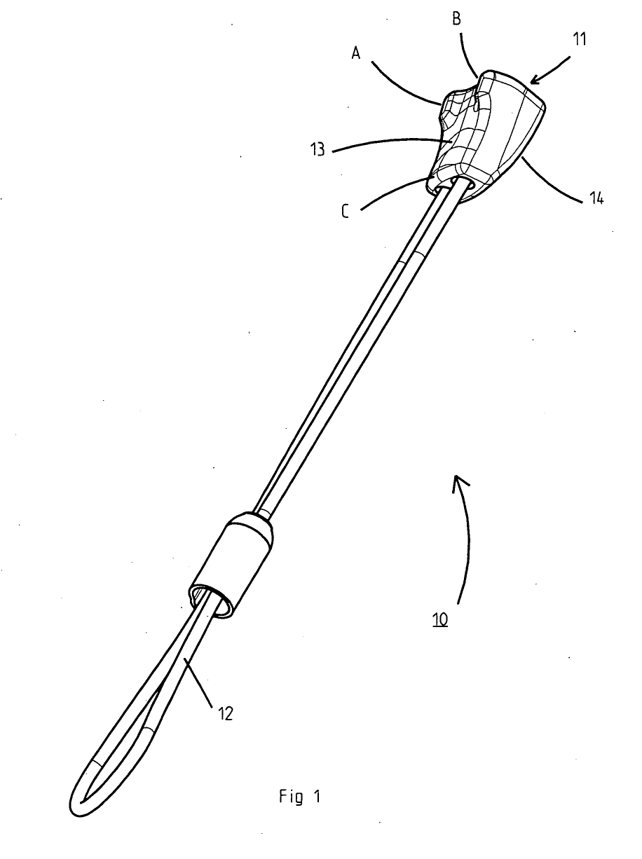

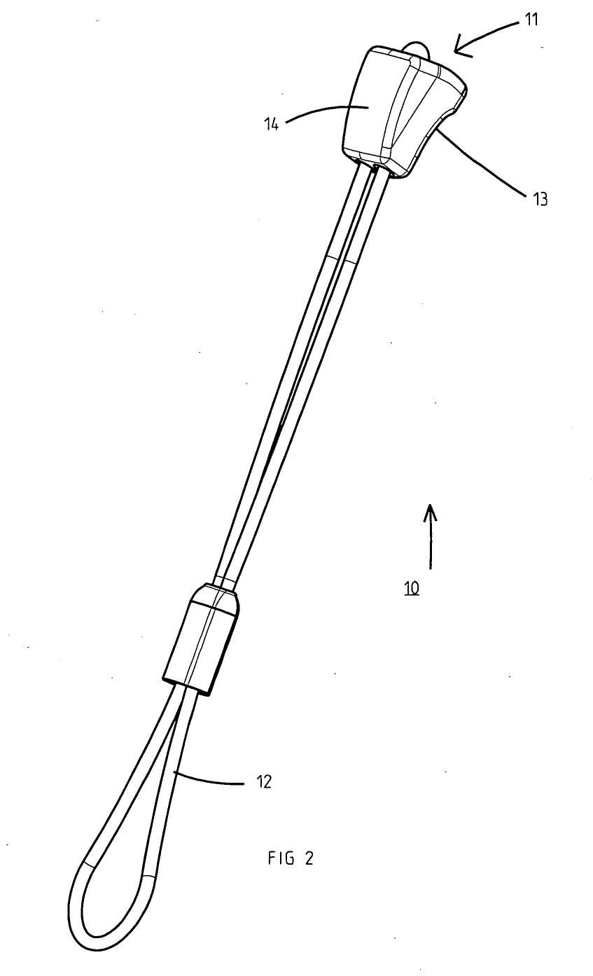

In FIGS. 1 to 4, a chock 10 for climbing and mountaineering is formed by a metal securing part 11 joined to an attachment means 12, in particular a rope in the form of a loop. The part 11 comprises on one side a first chocking face 13 and on the opposite side a second chocking face 14 so as to form nuts.

The first chocking face 13 presents an inwardly curved profile bounding three salient bearing zones A, B, C constituting a flat isostatic contact with the wall 15 of the crack 16.

The second chocking face 14 has an outwardly convex profile having a single bearing zone D forming a substantially pin-point contact of small surface with the other wall 17 of the crack 16. The bearing zone D of the pin-point contact is advantageously located close to the mid-part of the second chocking face 14 to achieve optimum wedging of the chock 10.

Preferably, the first chocking face 13 is concave and the second chocking face 14 is convex with a convexity oriented along two orthogonal axes.

It can be noted in FIG. 4 that the three bearing zones A, B, C of the first chocking face 13 are arranged at the angles of a triangle whose base passes through the two bearing zones A, B of the upper level and whose apex is the same as the third bearing zone C situated at a lower level. The bearing zone D of the second chocking face 14 extends substantially along the bisecting line originating from the apex.

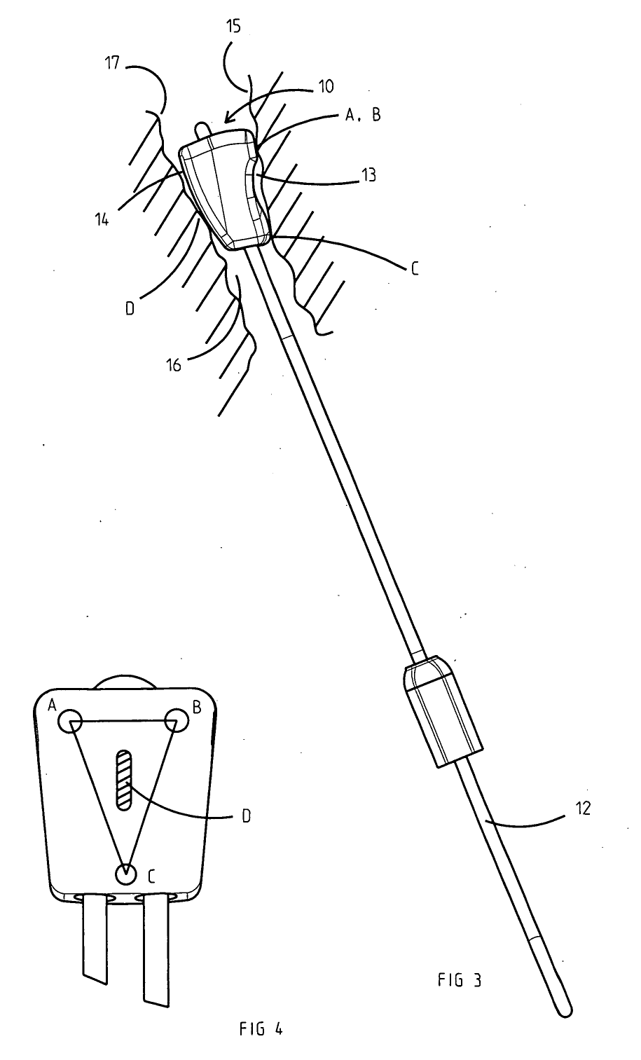

FIG. 3 shows the stable position of the chock 10 inserted in a crack 16 of irregular shape. The three bearing zones A, B, C of the first face 13 are located on the right side against the wall 15 and the bearing zone D of the second face 14 is on the left side against the wall 17.

Chocking of the chock 10 in the crack is performed by means of a plane and a pin-point contact. The plane enables an immobilization in translation and two rotation movements. The pin-point contact enables an immobilization in three translations. A link with a degree of freedom in rotation remains along the line perpendicular to the plane passing through the pin-point contact D.

1. Chock for climbing and mountaineering, comprising a securing part in the form of nuts designed to be inserted in a crack of a rock, said part comprising:
a first concave chocking face equipped with three bearing zones arranged at the angles of a triangle,
a second chocking face comprising a convex profile having a single bearing zone forming a pin-point contact of small surface,
and an attachment means fixed to the part,
wherein the three bearing zones are salient from the first chocking face forming a flat isostatic contact and the bearing zone of the pin-point contact is located close to the mid-part of the second chocking face.
